(19) United States
(12) Patent Application Publication
(10) Pub. No.: US 2015/0296046 A1
(43) Pub. Date: Oct. 15, 2015

(54) SELECTING AND DELIVERING DENSITY-SPECIFIC VISUAL DATA TO A CLIENT APPLICATION

(71) Applicant: International Business Machines Corporation, Armonk, NY (US)

(72) Inventors: Brian C. Adams, Woodstock, GA (US); Christopher E. Holladay, Marietta, GA (US); William D. Morgan, Atlanta, GA (US); Ryan L. Whitman, Sunny Side, GA (US)

(73) Assignee: International Business Machines Corporation, Armonk, NY (US)

(21) Appl. No.: 14/249,550

(22) Filed: Apr. 10, 2014

(51) Int. Cl. H04L 29/08; G06F 3/0484

(52) U.S. Cl. CPC H04L 67/32; G06F 3/04842

(57) ABSTRACT

Embodiments described herein provide approaches for automatically selecting and delivering density-specific visual content to a client application. Specifically, at least one approach includes receiving a request from a client application for visual data (e.g., an image resource), providing a metafile containing a set of available density levels of the visual data, and automatically selecting, from the metafile, a preferred density level from the set of available density levels of the visual data based on a set of display properties of the client application and/or client device. A second request is received for the image resource using a uniform resource locator (URL) corresponding to the preferred density level from the set of available density levels of the visual data. The visual data is then rendered and displayed at an optimal image density for the particular client application and/or client device, thus improving bandwidth, available computing power, and image load time.

### BACKGROUND

1. Field of the Invention

This invention relates generally to visual image display technologies and, more specifically, to selecting and delivering density-specific visual data to a client application.

2. Description of the Related Art

Information on the World Wide Web is typically made available by structuring the information into a visual presentation typically containing a number of images and/or graphics. The end user is presented with this information by viewing the information on a display after the information has been rendered into a visual format, e.g., by a web browser.

Client devices/applications with varying display densities must all render web image content at the same resolution, which is typically not ideal for higher density displays. One current art solution involves aligning multiple uniform resource locators (URLs) to specific devices, with image assets scaled accordingly in the content. However, this approach makes the code base a burden to maintain, and limits support to a few defined devices. Another current art solution delivers content appropriate for the highest possible display density, and forces the device to downscale the content to fit the display area. However, this wastes bandwidth and computing power, and requires a longer load time.

### SUMMARY

In general, embodiments described herein provide approaches for automatically selecting and delivering density-specific visual content to a client application. Specifically, at least one approach includes receiving a request from a client application for visual data (e.g., an image resource), providing a metafile containing a set of available density levels of the visual data, and automatically selecting, from the metafile, a preferred density level from the set of available density levels of the visual data based on a set of display properties of the client application and/or client device. A second request is received for the image resource using a uniform resource locator (URL) corresponding to the preferred density level from the set of available density levels of the visual data. The visual data is then rendered and displayed at an optimal image density for the particular client application and/or client device, thus improving bandwidth, available computing power, and image load time.

One aspect of the present invention includes a method for selecting and delivering density-specific visual content to a client application, the method comprising the computer-implemented steps of: receiving a request from a client application for visual data; providing a metafile containing a set of available density levels of the visual data; and automatically selecting, from the metafile, a preferred density level from the set of available density levels of the visual data based on a set of display properties of the client application.

Another aspect of the present invention provides a computer system for selecting and delivering density-specific visual content to a client application, the computer system comprising: a memory medium comprising program instructions; a bus coupled to the memory medium; and a processor, for executing the program instructions, coupled to an image density selector via the bus that when executing the program instructions causes the system to: receive a request from a client application for visual data; provide a metafile containing a set of available density levels of the visual data; and automatically select, from the metafile, a preferred density level from the set of available density levels of the visual data based on a set of display properties of the client application.

Another aspect of the present invention provides a method for selecting and delivering density-specific visual content to a client application, the method comprising: receiving a request from a client application for an image resource; providing, using at least one computing device, a metafile containing a set of available density levels of the image resource; and automatically selecting, from the metafile, using at least one computing device, one of the set of available density levels of the image resource based on a set of display properties of the client application.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 shows a pictorial representation of an implementation of the invention according to illustrative embodiments;

FIG. 2 shows an architecture in which density-specific visual content is selected and delivered according illustrative embodiments; and

FIG. 3 shows a process flow for selecting and delivering density-specific visual content to a client application according to illustrative embodiments.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION

Exemplary embodiments now will be described more fully herein with reference to the accompanying drawings, in which exemplary embodiments are shown. It will be appreciated that this disclosure may be embodied in many different forms and should not be construed as limited to the exemplary embodiments set forth herein. Rather, these exemplary embodiments are provided so that this disclosure will be thorough and complete and will fully convey the scope of this disclosure to those skilled in the art.

Furthermore, the terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Unless specifically stated otherwise, it may be appreciated that terms such as “processing,” “computing,” “determining,” “evaluating,” or the like, refer to the action and/or processes of a computer or computing system, or similar electronic data center device, that manipulates and/or transforms data represented as physical quantities (e.g., electronic) within the computing system's registers and/or memories into other data similarly represented as physical quantities within the computing system's memories, registers or other such information storage, transmission or viewing devices. The embodiments are not limited in this context.

As stated above, embodiments described herein provide approaches for automatically selecting and delivering density-specific visual content to a client application. Specifically, at least one approach includes receiving a request from a client application for visual data (e.g., an image resource), providing a metafile containing a set of available density levels of the visual data, and automatically selecting, from the metafile, a preferred density level from the set of available density levels of the visual data based on a set of display properties of the client application and/or client device. A second request is received for the image resource using a uniform resource locator (URL) corresponding to the preferred density level from the set of available density levels of the visual data. The visual data is then rendered and displayed at an optimal image density for the particular client application and/or client device, thus improving bandwidth, available computing power, and image load time.

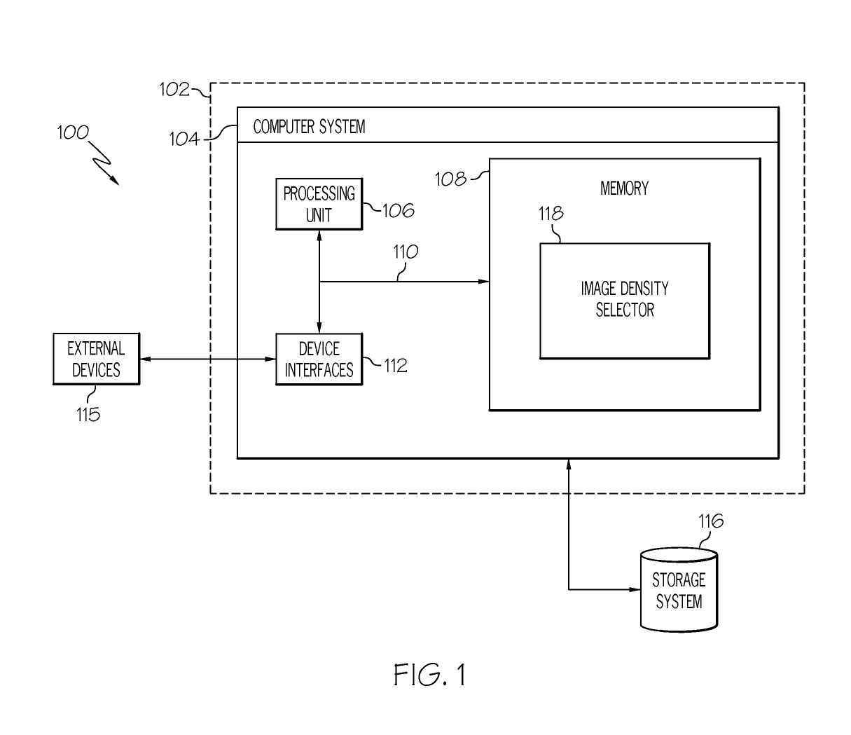

Referring now to FIG. 1, a computerized implementation 100 of an exemplary embodiment will be shown and described. As depicted, implementation 100 includes computer system 104 deployed within a computer infrastructure 102 (e.g., a client device). This is intended to demonstrate, among other things, that the present invention could be implemented within a network environment (e.g., the Internet, a wide area network (WAN), a local area network (LAN), a virtual private network (VPN), etc.), a cloud-computing environment, or on a stand-alone computer system. Communication throughout the network can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc., by a service provider who offers to implement, deploy, and/or perform the functions of the present invention for others.

Computer system 104 is intended to represent any type of computer system that may be implemented in deploying/realizing the teachings recited herein. In this particular example, computer system 104 represents an illustrative system for selecting and delivering density-specific visual content to a client application/device. It should be understood that any other computers implemented under the present invention may have different components/software, but will perform similar functions. As shown, computer system 104 includes a processing unit 106 capable of communicating with an image density selector 118 stored in memory 108, a bus 110, and device interfaces 112.

Processing unit 106 refers, generally, to any apparatus that performs logic operations, computational tasks, control functions, etc. A processor may include one or more subsystems, components, and/or other processors. A processor will typically include various logic components that operate using a clock signal to latch data, advance logic states, synchronize computations and logic operations, and/or provide other timing functions. During operation, processing unit 106 collects and routes signals representing inputs and outputs between external devices 115 and image density selector 118. The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different systems may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 106 executes computer program code, such as program code for operating image density selector 118, which is stored in memory 108 and/or storage system 116. While executing computer program code, processing unit 106 can read and/or write data to/from memory 108, storage system 116, and image density selector 118. Storage system 116 can include VCRs, DVRs, RAID arrays, USB hard drives, optical disk recorders, flash storage devices, and/or any other data processing and storage elements for storing and/or processing data.

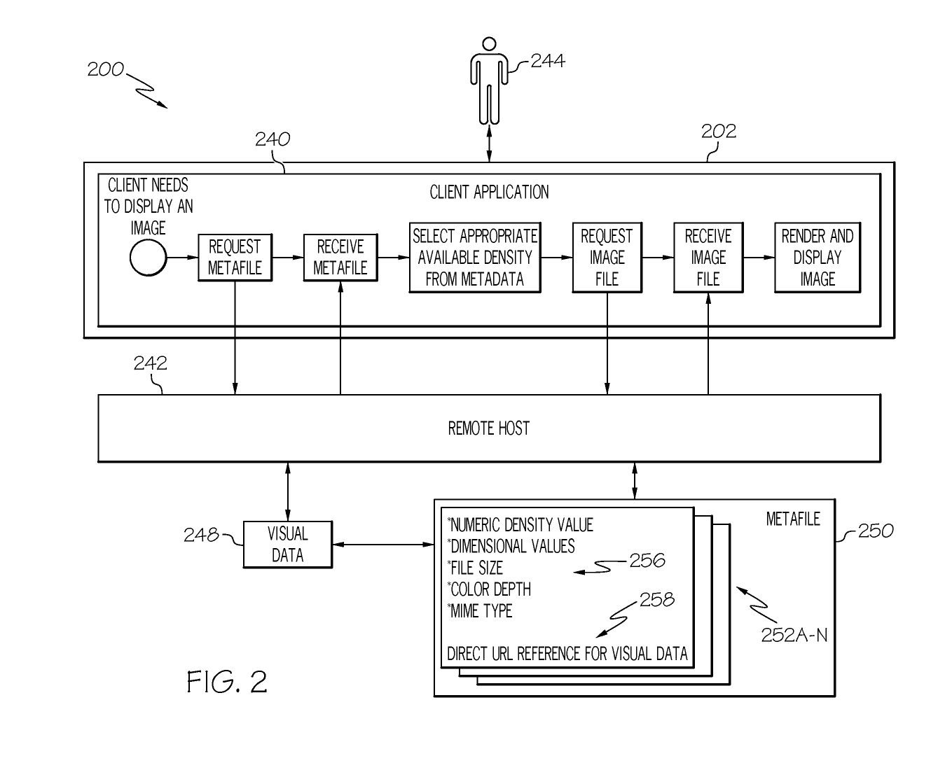

Referring now to FIG. 2, the structure and operation of a system 200 for selecting and delivering density-specific visual content to a client application according to exemplary embodiments will be described in greater detail. As illustrated, system 200 comprises a client application 240 (e.g., a web browser, social media application, etc.) operating with client device 202 (e.g., a smart phone, tablet computer, cellular/mobile phone, a desktop computer and monitor, etc.), which communicates with a remote host 242. During operation, a user 244 may desire to display an image via his/her device 202 and, to facilitate this, provides an input to device 202 to generate a request, from client application 240, for visual data 248 (e.g., an image resource). Instead of providing a direct URL to image resource 248 (e.g., a JPEG image file), device 202 is supplied a metafile 250, which contains a set of available density levels 252A-N for image resource 248. As used herein, a density level corresponds to a version of image resource 248 at a particular resolution (e.g., measured in dots per inch (dpi)). In one embodiment, metafile 250 includes a set of attributes 256 and a URL 258 for each density level 252A-N. As shown, attributes 256 include at least a numeric density value for image resource 248 at a given density level, dimensional values (e.g., width and height), file size, color depth, Internet media type (e.g., MIME), etc. Metafile URL 258 is used in any place where image file URLs would normally be used (e.g., IMG tags or background resources in HTML documents, etc.).

In one embodiment, client application 240 is a web browser, which receives documents and other resources from a network such as the Internet, via remote host 242. Documents/files that are received by the web browser are processed by a language interpreter, which includes an HTML unit. A language interpreter will process a document for presentation on a graphical display (not shown) of device 202. In particular, HTML statements are processed by the HTML unit for presentation. The web browser is presented as an example of a browser program in which the present invention may be embodied. The web browser is not meant to imply architectural limitations to the present invention. As used herein, the term “browser” encompasses any software application used to view or navigate for information or data (i.e. something that assists a user to browse) in a local or distributed data base where the distributed database is typically the Internet or World Wide Web.

It should also be noted that the present invention may also be applied to word processing and desktop publishing applications, as well as any other client application which involves placing images within electronic documents.

In various embodiments, metafile 250 may be implemented as a nested binary object, Extensible Markup Language (XML™), JavaScript™ Object Notation (JSON), or almost any other format including plain text. XML is a trademark of Massachusetts Institute of Technology, Institut National de Recherche en Informatique et en Automatique, or Keio University on behalf of the World Wide Web Consortium. JavaScript™ is a trademark or registered trademark of Oracle, Inc. in the US and other countries. A non-limiting exemplary metafile (e.g., XML) may be structured as follows:

<image width=“200” height=“300” basedensity=“72” densityunit=“dpi”>
<entry density=“72” width=“200” height=“300”
type=“image/png”><![CDATA[imagelocation/image72.png]]></entry>
<entry density=“120” width=“334” height=“500”
type=“image/png”><![CDATA[imagelocation/image120.png]]></entry>
<entry density=“160” width=“444” height=“666”
type=“image/png”><![CDATA[imagelocation/image160.jpg]]></entry>
<entry density=“240” width=“666” height=“1000”
type=“image/jpeg”><![CDATA[imagelocation/image240.jpg]]></entry>
<entry density=“320” width=“888” height=“1333”
type=“image/jpeg”><![CDATA[imagelocation/image320.jpg]]>
</entry> </image>

Client software of application 240 recognizes metafile 250 through various methods (e.g., MIME type, file header, file extension, etc.) and parses its content to extract set of attributes 256, which are used to select an entry that is most appropriate for the display context of application 240 and/or device 202. That is, client application 202 automatically selects a preferred density level from set of available density levels 252A-N based on a set of display properties of client application 240 and/or client device 202, wherein the preferred density level generally corresponds to a most appropriate/optimal density level for rendering and displaying image resource 248 on client application and/or device 202. Client application 240 scans parsed metafile 250 and compares the densities values listed in each density level 252A-N against an intrinsic density of the attached (or integrated) display of device 202. Since the display is a physical device, it typically has a single unchangeable density value. The lowest listed density value, which is equal to or greater than the display density, is selected. If all of the listed densities are less than the display density, the largest density is selected. It will be appreciated that in the event that only a single density level for image resource 248 is available, it will be selected by default.

Once the preferred density level is selected, a second request for image resource 248 is submitted via metafile URL 258 corresponding to the preferred density level. Image resource 248 is then returned to client application 240, where it is rendered and displayed at the preferred density level. By rendering and displaying image resource 248 at an optimal image density for client application 240 and/or client device 202, the system bandwidth, available computing power, and image load time are all improved.

It can be appreciated that the approaches disclosed herein can be used within a computer system to select and deliver density-specific visual data to a client application. In this case, as shown in FIGS. 1-2, the image density selector can be provided, and one or more systems for performing the processes described in the invention can be obtained and deployed to computer infrastructure 102 (FIG. 1). To this extent, the deployment can comprise one or more of (1) installing program code on a computing device, such as a computer system, from a computer-readable storage medium; (2) adding one or more computing devices to the infrastructure; and (3) incorporating and/or modifying one or more existing systems of the infrastructure to enable the infrastructure to perform the process actions of the invention.

The exemplary computer system 104 (FIG. 1) may be described in the general context of computer-executable instructions, such as program modules, being executed by a computer. Generally, program modules include routines, programs, people, components, logic, data structures, and so on, which perform particular tasks or implement particular abstract data types. Exemplary computer system 104 may be practiced in distributed computing environments where tasks are performed by remote processing devices that are linked through a communications network. In a distributed computing environment, program modules may be located in both local and remote computer storage media including memory storage devices.

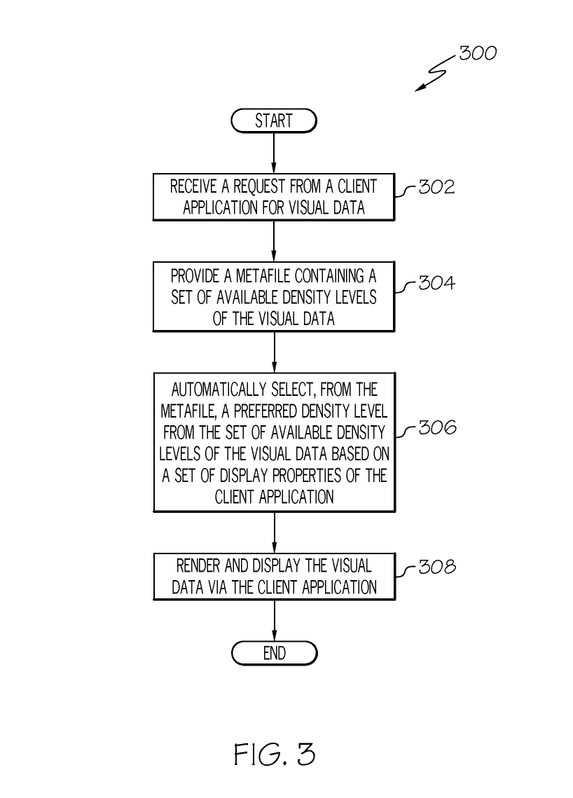

As depicted in FIG. 3, a system (e.g., computer system 104) carries out the methodologies disclosed herein. Shown is a process flow 300 for selecting and delivering density-specific visual content to a client application. At 302, a request for visual data is received from a client application. At 304, a metafile containing a set of available density levels of the visual data is provided. At 306, a preferred density level from the set of available density levels is automatically selected based on a set of display properties of the client application. At 308, the visual data is rendered and displayed via the client application.

Process flow 300 of FIG. 3 illustrates the architecture, functionality, and operation of possible implementations of systems, methods, and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the blocks might occur out of the order depicted in the figures. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, image density selector 118 may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may also be a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

It is apparent that there has been provided approaches for selecting and delivering density-specific visual data to a client application. While the invention has been particularly shown and described in conjunction with exemplary embodiments, it will be appreciated that variations and modifications will occur to those skilled in the art. Therefore, it is to be understood that the appended claims are intended to cover all such modifications and changes that fall within the true spirit of the invention.

What is claimed is:

1. A method for selecting and delivering density-specific visual content to a client application, the method comprising the computer-implemented steps of:
receiving a request from a client application for visual data;
providing a metafile containing a set of available density levels of the visual data; and
automatically selecting, from the metafile, a preferred density level from the set of available density levels of the visual data based on a set of display properties of the client application.

2. The method of claim 1, further comprising rendering the visual data via the client application.

3. The method of claim 1, the providing the metafile comprising providing a set of attributes and a uniform resource locator (URL) for each of the set of available density levels of the visual data.

4. The method of claim 3, the set of attributes comprising at least one of the following: a numeric density value, a dimensional value, file size, color depth, and an Internet media type.

5. The method of claim 3, further comprising receiving a second request for the visual data using the URL of the preferred density level from the set of available density levels of the visual data.

6. The method of claim 3, further comprising parsing the metafile to extract the set of attributes.

7. The method according to claim 1, the visual data comprising an image resource.

8. A computer system for selecting and delivering density-specific visual content to a client application, the computer system comprising:
a memory medium comprising program instructions;
a bus coupled to the memory medium; and
a processor, for executing the program instructions, coupled to an image density selector via the bus that when executing the program instructions causes the system to:
receive a request from a client application for visual data;
provide a metafile containing a set of available density levels of the visual data; and
automatically select, from the metafile, a preferred density level from the set of available density levels of the visual data based on a set of display properties of the client application.

9. The computer system of claim 8, further comprising program instructions to render the visual data via the client application.

10. The computer system of claim 8, the program instructions causing the system to provide the metafile further comprising program instructions to provide a set of attributes and a uniform resource locator (URL) for each of the set of available density levels of the visual data.

11. The computer system of claim 10, the set of attributes comprising at least one of the following: a numeric density value, a dimensional value, file size, color depth, and an Internet media type.

12. The computer system of claim 10, further comprising program instructions to receive a second request for the visual data using the URL of the preferred density level from the set of available density levels of the visual data.

13. The computer system of claim 8, further comprising program instructions to parse the metafile to extract the set of attributes.

14. The computer system of claim 8, the visual data comprising an image resource.

15. A method for selecting and delivering density-specific visual content to a client application, the method comprising:
receiving a request from a client application for an image resource;
providing, using at least one computing device, a metafile containing a set of available density levels of the image resource; and
automatically selecting, from the metafile, using at least one computing device, one of the set of available density levels of the image resource based on a set of display properties of the client application.

16. The method of claim 15, further comprising rendering, using at least one computing device, the image resource via the client application.

17. The method of claim 15, the providing the metafile comprising providing, using at least one computing device, a set of attributes and a uniform resource locator (URL) for each of the set of available density levels of the image resource.

18. The method of claim 17, the set of attributes comprising at least one of the following: a numeric density value, a dimensional value, file size, color depth, and an Internet media type.

19. The method of claim 17, further comprising receiving a second request for the image resource using the URL of the preferred density level from the set of available density levels of the image resource.

20. The method of claim 1, further comprising parsing the metafile to extract the set of attributes.
